(19) United States
(12) Patent Application Publication
(10) Pub. No.: US 2008/0256356 A1
(43) Pub. Date: Oct. 16, 2008

(54) SECURE MEDIA BROADCASTING USING TEMPORAL ACCESS CONTROL

(76) Inventors: Arun Kwangil Iyengar, Yorktown Heights, NY (US); Mudhakar Srivatsa, Atlanta, GA (US); Jian Yin, Bronx, NY (US)

Correspondence Address: RYAN, MASON & LEWIS, LLP, 90 FOREST AVENUE, LOCUST VALLEY, NY, 11560, US

(21) Appl. No.: 11/734,315

(22) Filed: Apr. 12, 2007

(51) Int. Cl. H04L 9/32

(52) U.S. Cl. 713/155

(57) ABSTRACT

Improved key management techniques are disclosed for temporal access control of one or more services in a computer network. For example, a method for providing access control in a client-server system includes the following steps. A client obtains an authorization key for a time interval. A server derives an encryption key corresponding to a given time and uses the encryption key to encrypt a message. The client derives a decryption key corresponding to the given time and decrypts the message.

### FIELD OF THE INVENTION

The present invention relates generally to enforcing access controls in a broadcast environment in a computer network where there is a plurality of subscribers. More specifically, this invention provides a key management system for providing temporal access control on such broadcast services.

### BACKGROUND OF THE INVENTION

Secure media broadcasting from a server over the Internet or broadcast medium to a number of clients poses unique security challenges. One important problem for such broadcast services is the need to enforce access control on a large number of subscribers in a public broadcast. In such a system, a user typically subscribes to a broadcast service for some specified time interval. A common solution is to encrypt the broadcast data and to disclose the decryption key to legitimate receivers only. However, a problem arises with attempting to securely, scalably and efficiently establish a shared secret amongst the legitimate receivers. Further, and most importantly, a problem arises with attempting to manage the shared secret key as subscribers join or leave.

A common solution for distributing the secret decryption key (group key) only to the legitimate receivers is to use a central server for key management. Key management is complicated by dynamic groups, where users may join or leave at any time. Users should be able to decrypt the data when they are a member of the group of authorized users. The key server needs to update the group key on member join and leave events. Then, the Key Distribution Center (KDC) must send one message per group member u that includes the updated group key encrypted with a user key K(u). Changing the key for a large group incurs scalability, reliability and efficiency problems.

A Logical Key Hierarchy (LKH) proposed by Wong et al. (see C. K. Wong, M. Gouda, and S. S. Lam, “Secure group communications using key graphs,” Proceedings of ACM SIGCOMM, Vancouver, Canada, September 1998) attempts to solve the scalability and efficiency of the group key update protocol by building a logical key hierarchy on the set of authorized users. An Efficient Logical Key Distribution protocol (ELK) enhances the LKH protocol to deal with arbitrary packet losses, including key update messages. However, with the LKH and ELK approaches, the storage cost at the KDC grows linearly with the number of users N. Also, in the case of multiple KDCs, the LKH and ELK approaches both have a centralized key graph data structure that is non-trivial and needs to be distributed amongst the multiple KDCs. Further, with the LKE and ELK approaches, when a new user joins the set of authorized users, at least O(log₂N) keys must be encrypted and updated in the key graph, and a key update message must be broadcasted to all the users.

Accordingly, a need exists for improved key management techniques for providing temporal access control on broadcast services.

### SUMMARY OF THE INVENTION

Principles of the invention provide improved key management techniques for temporal access control of one or more services in a computer network.

For example, in one aspect of the invention, a method for providing access control in a client-server system includes the following steps. A client obtains an authorization key for a time interval. A server derives an encryption key corresponding to a given time and uses the encryption key to encrypt a message. The client derives a decryption key corresponding to the given time and decrypts the message.

The time interval may be divided into secondary time intervals which are arranged in a tree structure. Each node of the tree may represent one of the secondary time intervals and, with the exception of the lowest level in the tree structure, each node in the tree structure may have N child nodes. A key for each secondary time interval at a k-th level of the tree may be derived by performing k hash functions on a master key for the time interval represented by the root node of the tree structure. N may equal two. The given time may be within the time interval. The method may further include the step of encrypting the message with a client key that is unique to each client. The time interval may be split into two to the power n time intervals, wherein an encryption key is derived from the authorization key for each of the time intervals, where n is an integer. Any encryption key for any of the two to the power n time intervals can be derived from a master key by performing at most n hash functions on the master key.

These and other objects, features and advantages of the present invention will become apparent from the following detailed description of illustrative embodiments thereof which is to be read in connection with the accompanying drawings.

### BRIEF DESCRIPTION OF THE DRAWINGS

FIG. 1 depicts a pictorial representation of a network of data processing systems in which illustrative embodiments may be implemented.

FIG. 2 depicts a block diagram of a data processing system in which illustrative embodiments may be implemented.

FIG. 3 depicts a flow diagram of the encryption of a packet at time t and the broadcasting of the encrypted packet by a broadcast server, according to an illustrative embodiment.

FIG. 4 depicts a flow diagram of the reception of a broadcasted encrypted packet a time t by a client or subscriber which then computes the decryption key for time t and decrypts the packet from the broadcast server, according to an illustrative embodiment.

FIG. 5 depicts a flow diagram illustrating the derivation of encryption keys from intermediate keys that are stored in cache memory, according to an illustrative embodiment.

FIG. 6 depicts a flow diagram illustrating the derivation of encryption keys for different times t, according to an illustrative embodiment.

FIG. 7 graphically illustrates an authorization key tree structure where each element is associated with a time interval, according to an illustrative embodiment.

### DETAILED DESCRIPTION OF PREFERRED EMBODIMENTS

An illustrative key management system and methodology for temporal access control in a computer network will be described below in the context of a streaming multimedia broadcast environment. However, principles of the invention are not limited only to streaming multimedia broadcast environments, and may thus be applied to other computer network environments wherein secure key management for temporal access control is desired.

Consider groups specified by a temporal authorization model in situations where there is wide spread audio/video streaming over a network to a large number of users. In this context, a multimedia broadcast service has a payment gateway that allows users to buy permissions to access the multimedia for a time interval (a, b). In exchange for a payment, the gateway returns a temporal authorization that permits a user u to use a broadcast service for the given time interval. A multimedia packet broadcast at time t should be intelligible to the group of users that have subscribed to the service for some interval (a, b) such that a≦t≦b.

With the temporal authorization model of the invention, a key management protocol is constructed which does not require any key update messages. The absence of a key update protocol obviates the problem of arbitrary packet losses in key update messages. Principles of the invention do not require a broadcast channel between the payment gateway (or the key distribution center KDC) and the users. Implementations of the invention incur a small join cost for a newly joining node, zero leave cost, and a small computation cost for processing the broadcasted multimedia packets. Further, implementations of the invention use only a small and constant stateless storage at the key distribution center. Further, the KDC need only store the master key MK. The remaining keys can be computed on the fly. On the other hand, with the LKH and the ELK approaches, the storage cost at the KDC grows linearly with the number of users N. Also, with an embodiment of this invention, the storage cost at a user is only logarithmic in the length of the subscription time interval.

With an embodiment of this invention, multiple KDC servers can be used by merely sharing the master key MK amongst them. Also, since all temporal authorization keys are derivable from the master key MK, the KDC servers are not required to share and update a common data structure. This allows on-demand creation of KDC server replicas to handle bursty KDC traffic.

One embodiment of an inventive algorithm efficiently supports temporal authorization at very low granularities (δₜ˜10⁻³ or 10⁻⁶ seconds). Another advantage of the invention is that the key need not be updated once it is given to the user. A join operation requires only an interaction between the KDC and the new user; a leave operation is cost free. One should note that the temporal authorization model simplifies the user leave operation by a priori determining the time interval (a, b). On the other hand, the LKH and ELK approach have to send at O(log₂N) size message to all the users. Further, the KDC has to maintain the set of active users in order to maintain and update the key graph.

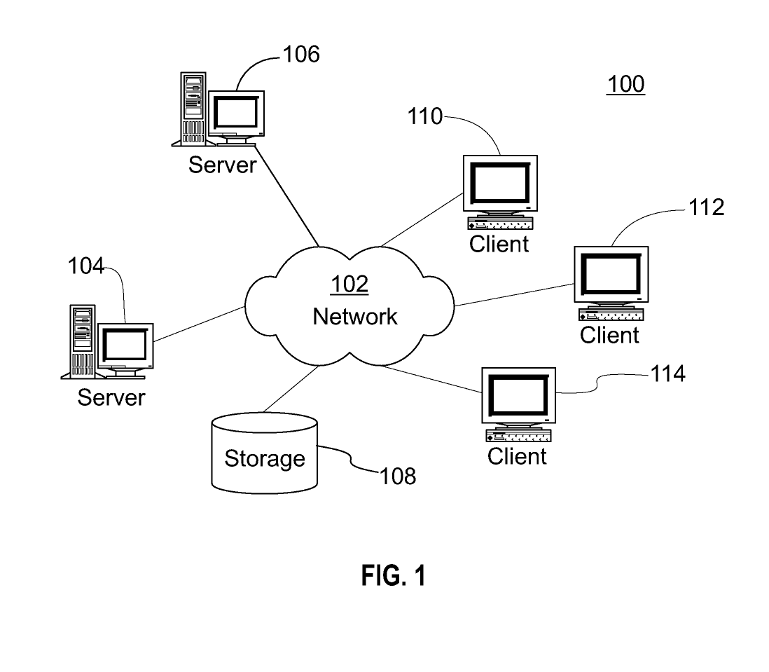

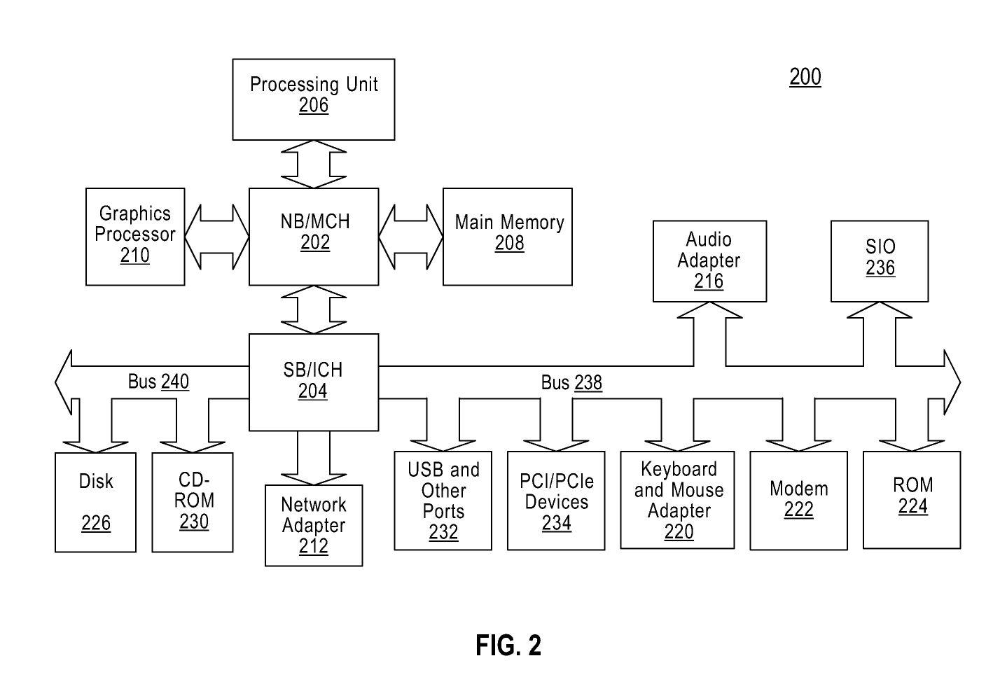

With reference now to the figures and in particular with reference to FIGS. 1 and 2, exemplary diagrams of data processing environments are provided in which embodiments of the invention may be implemented. It should be appreciated that FIGS. 1 and 2 are only exemplary and are not intended to assert or imply any limitation with regard to the environments in which embodiments of the invention may be implemented. Many modifications to the depicted environments may be made without departing from the spirit and scope of the illustrative embodiments.

FIG. 1 depicts a representation of a network of data processing systems in which illustrative embodiments may be implemented. Network data processing system 100 is a network of computers in which embodiments of the invention may be implemented. Network data processing system 100 contains network 102, which is the medium used to provide communications links between various devices and computers connected together within network data processing system 100. Network 102 may include connections, such as wire, wireless communication links, or fiber optic cables. Network 102 also represents a broadcast/multicast medium, e.g., Internet, Internet Protocol (IP) multicast, local area network (LAN) broadcast, or a wireless broadcast.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments of the invention may be implemented. Data processing system 200 is an example of a computer, such as server 104 or client 110 in FIG. 1, in which computer executable code or instructions implementing the processes for embodiments of the invention may be located.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc.).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1 and 2 and above-described examples are not meant to imply architectural limitations. For example, data processing system 200 also may be a tablet computer, laptop computer, or telephone device in addition to taking the form of a PDA.

The illustrative embodiments provide for a computer implemented method, data processing system, and computer executable program code for compiling source code. The computer implemented methods of the illustrative embodiments of the invention may be performed in a data processing system, such as data processing system 100 shown in FIG. 1 or data processing system 200 shown in FIG. 2.

Principles of the invention provide techniques for handling temporal authorizations in multimedia broadcast services. Consider the case where a user needs to subscribe (by paying a fee) to access the broadcast service over the internet. Each subscription has a lifetime indicated by a time interval (a, b). When a user subscribes for a broadcast service S from time (a, b) the service provider issues a key K^{a,b} to the user u. This ensures that:
Given K^{a,b}, a user u can efficiently derive K^{t,t}; if a≦t≦b.
Given K^{a,b}, it is computationally infeasible for a user u to guess K^{t,t} if t<a or t>b.

The primitive described above helps us to construct a very simple and efficient protocol for temporal access control on broadcast services.

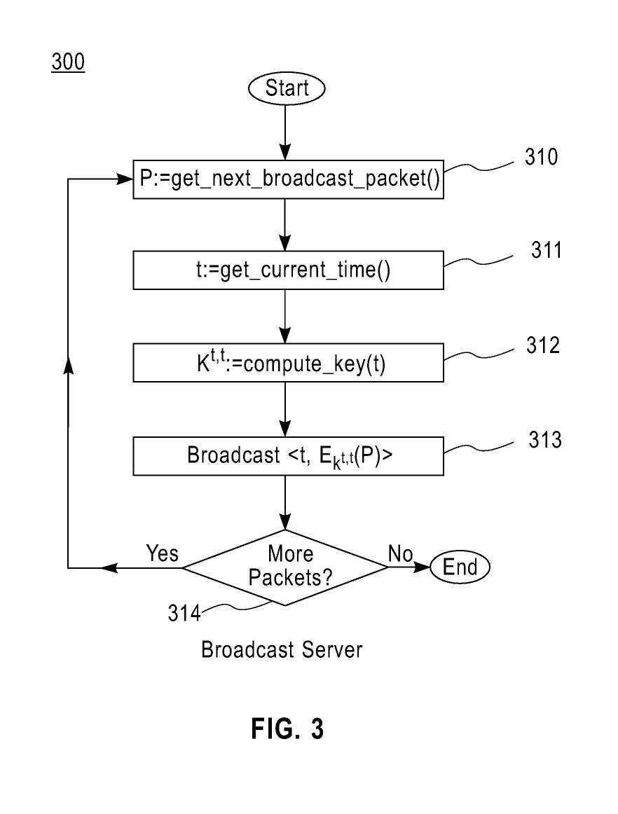

Referring now to FIG. 3, a flow diagram is shown of a methodology 300 for the encryption of a packet at time t and the broadcasting of the encrypted packet by a broadcast server, according to an illustrative embodiment.

At any given time instant t, the service provider broadcasts a packet P (of say, audio/video data) as follows (see step 310.):
Obtain the current time instant t and compute K^{t,t} (see steps 311 and 312.)
Broadcast <t, E_{Kt,t}(P)> on a public network (see step 313.)

The above process is repeated (see step 314) used for each packet to be transmitted.

E_{K}(x) denotes an encryption of a string x using a symmetric key encryption algorithm E and a key K. Note that all users can potentially receive the broadcast message.

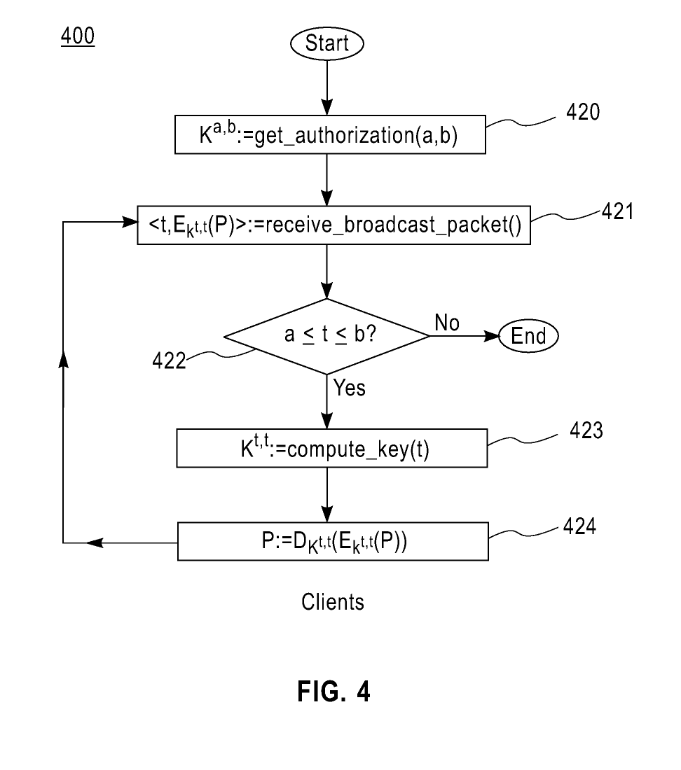

Referring now to FIG. 4, a flow diagram is shown of a methodology 400 for the reception of a broadcasted encrypted packet a time t by a client or subscriber which then computes the decryption key for time t and decrypts the packet from the broadcast server, according to an illustrative embodiment.

An authorized subscriber decrypts the payload P as follows:
Receive the broadcast message <t, E_{Kt,t}(P)>. Note that the time instant t is in plain-text (see step 421).
A subscriber is authorized if it has a temporal authorization for some time period (a, b) (see step 420.) such that a≦t≦b (see step 422.). An authorized subscriber can compute the decryption key K^{t,t} from K^{a,b} (see step 423) and decrypt the broadcast message to obtain the payload P (see step 424.).

A property of the key K^{a,b} ensures that one can efficiently compute K^{t,t} from K^{a,b} if and only if a≦t≦b.

Described below are techniques for constructing keys that satisfy the primitive described above. Let δₜ seconds denote the smallest time granularity of interest. Let time equal to t denote the t^{th} time unit in a year, where one unit time=δₜ seconds. Let (0, Tₘₐₓ) denote the time horizon of interest. Associate a key K^{t,t}(S) as the authorization key that permits a user u to access a broadcast service S at time t. One implementation of the algorithm provides that Tₘₐₓ authorization keys are used to authorize a user for Tₘₐₓ time units. Using δₜ=1 second, an authorization for one year would involve 3.15*10⁷ authorization keys. The authorization costs are reduced by building a one-way authorization key tree. The key tree reduces the number of authorization keys to, at most, 2log₂ Tₘₐₓ−2 (Tₘₐₓ>2). Hence, with no more than 48 authorization keys, one can handle all temporal authorizations at the granularity of one second. That is, the maximum number of authorization keys per subscription is 48. All the other keys can be generated on the fly using logarithmic number of hash computations.

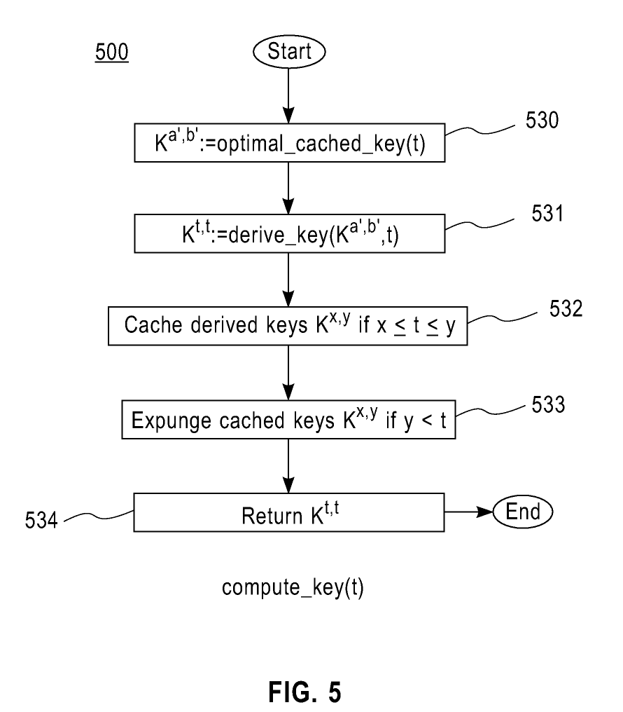

Referring now to FIG. 5, a flow diagram shows a methodology 500 for the derivation of encryption keys from intermediate keys that are stored in cache memory, according to an illustrative embodiment. In accordance with the methodology shown in FIG. 5, one can additionally use a caching mechanism to decrease the key derivation cost.

Let us suppose that a user received a broadcast packet P at time t. Then, the user would compute K^{t,t} from its authorization key K^{a,b} (a≦t≦b). In this process, the user computes several intermediate keys K^{a′,b′} (a≦a′≦b′≦b) (see step 530). The user can cache these intermediate keys for future use. Say, the user were to receive its next broadcast packet P′ at time t′, then the user could potentially compute K^{t′,t′} from some K^{a′,b′} such that a≦a′≦t≦t′≦b′≦b (see step 531). Indeed, this would require only log₂((b′−a′)/δₜ) applications of the hash function H (b′−a′<b−a). One can show that if the mean inter-packet arrival time is 1/rate then, the mean computation cost is −H*log₂(rate*δₜ) (assuming, δₜ<1/rate). When the methodology derives K^{t,t} from some K^{a′,b′}, it computes several intermediate keys K^{x,y} such that a′≦x≦t≦y≦b′. Keys K^{x,y} are cached for future use (step 532). Say, the next packet arrives at t′>t, then one can derive K^{t,t} it from a cached key K^{x,y} if x≦t′≦y. The methodology expunges cache keys K^{x,y} when y<1 (step 533). The methodology returns K^{t,t} in step 534.

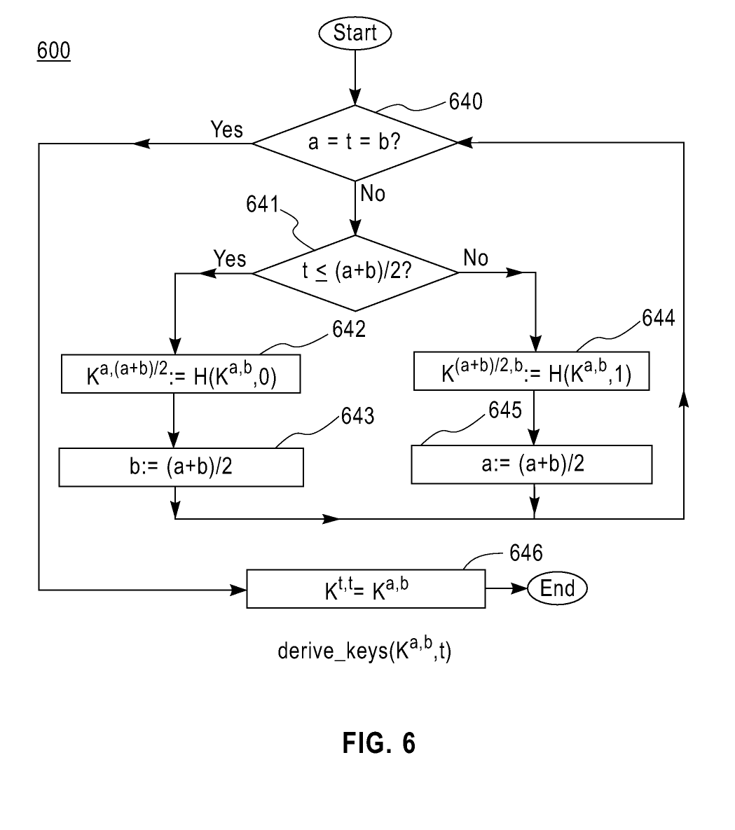

Referring now to FIG. 6, a flow diagram shows a methodology 600 for the derivation of encryption keys for different times t, according to an illustrative embodiment.

An authorization key tree is constructed as follows. Each element in the key tree is associated with a time interval. At the root of the key tree is (0, Tₘₐₓ). Each element (a, b) in the key tree has two children (a, (a+b)/2) and ((a+b)/2+1, b). Associate an authorization key K^{a,b}(S) with every element (a, b) in the key tree. The keys associated with the elements of the key tree are derived recursively as follows:
K^{a,(a+b)/2}(S)=H(K^{a,b}(S), 0) (see steps 640, 641 and 642).
K^{(a+b)/2+1,b}(S)=H(K^{a,b}(S), 1) (see steps 640, 641 and 644).
   The recursive operation is shown in steps 643 and 645 for the children of (a, (a+b)/2) and ((a+b)/2+1, b) for deriving the keys where H is a one-way hash function like MD5 or SHA1 (Secure Hash Algorithm). The SHA algorithms were developed by the National Security Agency (NSA) and published as a U.S. government standard. The MD5 algorithm, developed by Professor Ronald L Rivest of MIT, receives an input message of arbitrary length and generates as output a 128-bit “fingerprint” or “message digest” of the input. The root of the key tree has a key computed using the KDC's secret master key MK, and S is the name of the broadcast service:
K^{0,Tax}(S)=H_{MK}(S)

H_{K} denotes a keyed pseudo-random function like HMAC-MD5 (Hash Message Authentication Code-Message Digest 5) or HMAC-SHA1 (Hash Message Authentication Code-Secure Hash Algorithm).

In step 640, a check is made to determine if a=t=b. When this is true, K^{t,t}=K^{a,b} (step 646) and the process ends.

Thus, as shown, methodology 600 provides for iterative hashing of a key until t is in some small interval at the granularity that is desired. Since the smallest time unit is δt, a=t=b represents a time interval (a, a+δt).

Observe that given K^{a,b}(S), one can derive all keys {K^{t,t}(S): a≦t≦c b}. Also, deriving the key K^{t,t}(S) for any a≦t≦b from K^{a,b}(S) requires no more than log₂(b−a) applications of the hash function H.

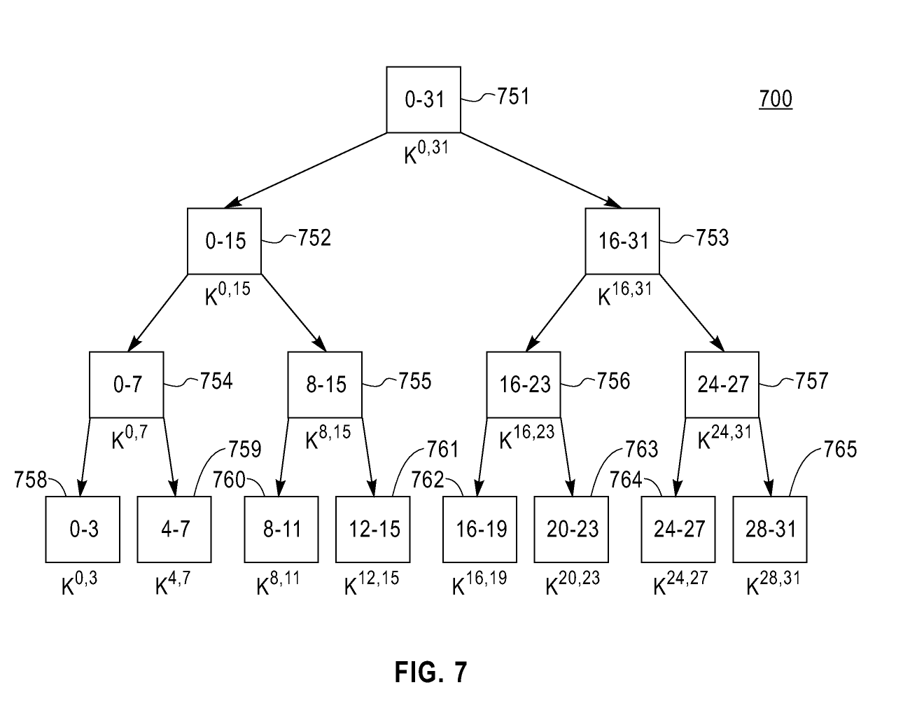

FIG. 7 illustrates the construction of a key tree in accordance with an embodiment of the invention. The construction assumes Tₘₐₓ=31 time units. The key tree construction process derives K^{0,31}(S)=H_{MK}(S) (see block 751). Then, the process computes K^{0,15}(S)=H(K^{0,31}(S), 0) and K^{16,31}(S)=H(K^{0,31}(S), 1) (see blocks 752 and 753, respectively). One can recursively extend this definition to any arbitrarily small time granularity at the expense of additional key derivation cost. For example, K^{0,7}=H(K^{0,15}(S), 0) and K^{8,15}=H(K^{0,15}(S), 1) (see blocks 754 and 755, respectively). Similarly, K^{16,23}=H(K^{16,31}(S), 0) and K^{24,31}=H(K^{16,31} (S), 1) (see blocks 756 and 757, respectively). Recursively, applying the above to the last four keys (754, 755, 756 and 757) yields eight keys: K^{0,3}; K^{4,7}; K^{8,11}; K^{12,15}; K^{16,19}; K^{20,23}; K^{24,27}; and K^{28,31} (see blocks 758, 759, 760, 761, 762, 763, 764 and 765, respectively).

Note that the total number of keys is not logarithmic. However, the process need not generate or store all the keys. That is, the keys are computed on the fly from the root key. Each authorization key computation takes only logarithmic time (logarithmic number of hashes). Also, the size of one authorization (that is, one time interval (a, b)) is logarithmic.

Given any arbitrary time range (a, b), one can show that the range can be partitioned into no more than 2(log₂(Tₘₐₓ/δₜ))−2 elements in the key tree. For example, given a time interval (8, 19), the time interval is partitioned into two subintervals (8, 15) and (16, 19). Temporal authorization is provided for a time interval (8, 19) by issuing two authorization keys K^{8,15}(S) and K^{16,19}(S). In general, if one uses a r-ary key tree (r≧2), any range can always be subdivided into no more than r(logᵣ(Tₘₐₓ/δₜ)−1) subintervals (Tₘₐₓ>r). One can show that this is a monotonically increasing function in r (for r≧2) and thus has a minimum value when r=2. One can also show that if the time interval (a, b) were chosen uniformly and randomly then on an average (a, b) can be subdivided into (r−1)logᵣ((b−a)/δₜ) subintervals (Tₘₐₓ/δₜ>b−a>r). One can show that this is a monotonically increasing function in r (for r≧2) and thus has a minimum value at r=2. However, as r increases the height of the key tree (logᵣ(Tₘₐₓ/δₜ)) decreases, that is, the cost of key derivation decreases monotonically with r.

Thus, as explained above, principles of the invention handle the case of a user joining the set of authorized users in the following way. When a user joins the system, it subscribes for some time interval (a, b). The KDC sends the authorization key K^{a,b} to the user. The KDC may have to derive K^{a,b} from the root key. This derivation incurs logarithmic space and time cost. The only information required for the new user is the authorization key K^{a,b}. Thus, none of the other users in the system are involved when one user joins the system. This eliminates the need for a key update protocol, which is typically very communication intensive.

On the other hand, principles of the invention advantageously handle the case of a user leaving the set of authorized users in the following way. When a user's subscription (a, b) terminates, the user will no longer be able to decrypt the broadcast packets. For example, a packet broadcast at time t′>b will be encrypted with K^{t′,t′}. The property of our authorization keys ensure that K^{t,t} is derivable from K^{a,b} if and only if a≦t≦b. Since t′>b, the user cannot guess K^{t′,t′} and thus cannot decrypt the broadcast packet at time t′. This is the reason a user's leave cost is zero. The KDC or the rest of the users are unaffected when one user leaves.

It is to be appreciated that the invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. In a client-server system, a method for providing access control, comprising the steps of:
a client obtaining an authorization key for a time interval;
a server deriving an encryption key corresponding to a given time and using said encryption key to encrypt a message; and
the client deriving a decryption key corresponding to the given time and decrypting the message.

2. The method of claim 1, wherein said time interval is divided into secondary time intervals which are arranged in a tree structure.

3. The method of claim 2, wherein each node of said tree represents one of said secondary time intervals, and wherein, with the exception of the lowest level in said tree structure, each node in said tree structure has N child nodes.

4. The method of claim 3, wherein a key for each said secondary time interval at a k-th level of said tree is derived by performing k hash functions on a master key for said time interval represented by the root node of said tree structure.

5. The method of claim 3, wherein N equals two.

6. The method of claim 1, wherein said given time is contained within said time interval.

7. The method of claim 1, further comprising the step of encrypting said message with a client key that is unique to each said client.

8. The method of claim 1, wherein said time interval is split into two to the power n time intervals, wherein an encryption key is derived from said authorization key for each of said time intervals, where n is an integer.

9. The method of claim 8, wherein any said encryption key for any of said two to the power n time intervals can be derived from a master key by performing at most n hash functions on said master key.

10. A system for providing access control, said system comprising:
a client processor for obtaining an authorization key for a time interval; and
a server processor for deriving an encryption key corresponding to a given time and using said encryption key to encrypt a message;
wherein the client processor derives a decryption key corresponding to the given time and decrypts the message.

11. The system of claim 10, wherein said time interval is divided into secondary time intervals which are arranged in a tree structure.

12. The system of claim 11, wherein each node of said tree represents one of said secondary time intervals, and wherein, with the exception of the lowest level in said tree structure, each node in said tree structure has N child nodes.

13. The system of claim 12, wherein a key for each said secondary time interval at a k-th level of said tree is derived by performing k hash functions on a master key for said time interval represented by the root node of said tree structure.

14. The system of claim 12, wherein N equals two.

15. The system of claim 10, wherein said given time is contained within said time interval.

16. The system of claim 10, wherein the server processor is further operative to encrypt said message with a client key that is unique to each said client.

17. The system of claim 10, wherein said time interval is split into two to the power n time intervals, wherein an encryption key is derived from said authorization key for each of said time intervals, where n is an integer.

18. The system of claim 17, wherein any said encryption key for any of said two to the power n time intervals can be derived from a master key by performing at most n hash functions on said master key.

19. A program storage device readable by a digital processing apparatus and having a program of instructions which are tangibly embodied on the storage device and which are executable by the processing apparatus to perform, in a client-server system, a method for providing access control, the method comprising:
a client obtaining an authorization key for a time interval;
a server deriving an encryption key corresponding to a given time and using said encryption key to encrypt a message; and
the client deriving a decryption key corresponding to the given time and decrypting the message.

20. The program storage device of claim 19, wherein said time interval is divided into secondary time intervals which are arranged in a tree structure.
